(19) United States
(12) Patent Application Publication
(10) Pub. No.: US 2026/0326803 A1
(43) Pub. Date: Oct. 22, 2026

(54) COLLAPSIBLE CART

(71) Applicant: Zhongshan Weihong Daily Necessities Co., Ltd., Zhongshan (CN)

(72) Inventor: Yidong JIANG, Zhongshan (CN)

(21) Appl. No.: 19/700,769

(22) Filed: Jun. 8, 2026

(30) Foreign Application Priority Data
Dec. 8, 2025 (CN) 202522598752.9

(51) Int. Cl. B62B 3/02; B62B 3/00

(52) U.S. Cl. CPC B62B 3/025; B62B 3/007; B62B 2205/003; B62B 2205/06; B62B 2205/24

(57) ABSTRACT

The present invention discloses a collapsible cart, which comprises a front frame, a rear frame and at least one side frame configured between the front frame and the rear frame for folding and unfolding the cart; wherein a folding mechanism is configured in a middle of the side frame for driving the front frame and the rear frame to move toward or away from the folding mechanism so as to achieve folding and unfolding of the cart. The folding mechanism drives the front frame and the rear frame to synchronously move toward or away from the folding mechanism, which realizes dynamic linkage during unfolding and folding of the cart, thereby effectively reducing gaps between the front frame and the rear frame after folding, optimizing space utilization of the folding, and significantly improving folding compactness while ensuring structural strength.

### RELATED APPLICATIONS

The present patent document claims the benefit of priority to Patent Application No. 202522598752.9, filed Dec. 8, 2025, and entitled “COLLAPSIBLE CART,” the entire contents of each of which are incorporated herein by reference.

### BACKGROUND

### 1. Technical Field

The present invention relates to the technical field of collapsible cart, in particular to a collapsible cart.

### 2. Background Information

To meet portability requirements, most of the conventional collapsible cart adopt a single-point or multi-point pivot structure to achieve quick folding. It features simple operation and a lightweight design suitable for multiple scenarios. Through a linkage mechanism or concealed pivot connection, it maintains favorable deployment stability and convenient storage in routine use.

However, when existing collapsible carts are folded, the front frame and the rear frame cannot be closely attached due to constraints of the rotating positions, resulting in obvious gaps in the folded state and an increased occupied space. Although some designs realize linked folding, the front and rear frames are still restricted by their rotating positions during folding and cannot be closely fitted together. Alternatively, certain existing collapsible carts adopt complicated mechanisms to improve folding compactness and stability, yet the operation is relatively cumbersome, which reduces the compact storage performance and structural strength of the collapsible cart. Therefore, a compact collapsible cart is needed.

### BRIEF SUMMARY

In order to address the technical problems of obvious gaps between the front frame and the rear frame and large occupied space after existing collapsible carts are folded, the present invention provides a compact collapsible cart.

The present invention is achieved by the following technical solutions.

A collapsible cart comprises a front frame, a rear frame and at least one side frame configured between the front frame and the rear frame for unfolding and folding the cart; wherein a folding mechanism is configured in a middle of the side frame for driving both the front frame and the rear frame to move toward or away from the folding mechanism for unfolding and folding of the cart. The side frame is configured to fold or unfold correspondingly with a movement of the folding mechanism so that the front and the rear frame are gathered or expanded.

Wherein the folding mechanism drives the front frame and the rear frame to synchronously move toward or away from the folding mechanism, which realizes dynamic linkage during unfolding and folding of the cart, thereby effectively reducing gaps between the front frame and the rear frame after folding, optimizing space utilization of the folding, and significantly improving folding compactness while ensuring structural strength.

The collapsible cart as mentioned above, wherein the side frame comprises a front top rod and a front bottom rod whose front ends are pivotally connected to an upper side and a lower side of the front frame respectively, and a rear top rod and a rear bottom rod whose rear ends are pivotally connected to an upper side and a lower side of the rear frame; wherein the folding mechanism comprises a first folding member pivotally connected to both the front top rod and the rear top rod, a second folding member pivotally connected to both the front bottom rod and the rear bottom rod.

The collapsible cart as mentioned above, wherein one side of the first folding member is configured with a first rotating end fixedly connected to the front top rod, the other side is configured with a second rotating end fixedly connected to the rear top rod, and the first rotating end and the second rotating end are rotatably connected;
one side of the second folding member is configured with a front bottom pivot end fixedly connected to the front bottom rod, and the other side of the second folding member is configured with a rear bottom pivot end fixedly connected to the rear bottom rod, wherein the front bottom pivot end and the rear bottom pivot end are rotatably connected.

The collapsible cart as mentioned above, wherein a rotational axis of the first folding member is parallel to a rotational axis of the second folding member, and a plane defined by rotational axes of the first folding member and the second folding member is parallel to planes of the front frame and the rear frame.

The collapsible cart as mentioned above, wherein an auxiliary folding rod is configured between the first folding member and the second folding member for connection therebetween; one end of the auxiliary folding rod is rotatably connected to the first folding member, and the other end is rotatably connected to the second folding member; wherein the side frame is axisymmetrical about the auxiliary folding rod.

The collapsible cart as mentioned above, wherein the folding mechanism further comprises a sliding sleeve disposed on the auxiliary folding rod which moves along an axis direction of the auxiliary folding rod, and a first linking member and a second linking member which slide along with the sliding sleeve and respectively drive the front bottom rod and the rear bottom rod to move.

The collapsible cart as mentioned above, wherein one end of the first linking member is pivotally connected to the sliding sleeve, the other end is pivotally connected to the front bottom rod; wherein one end of the second linking member is pivotally connected to the sliding sleeve, the other end is pivotally connected to the rear bottom rod.

The collapsible cart as mentioned above, wherein the first linking member and the second linking member is axisymmetrical about the auxiliary folding rod.

The collapsible cart as mentioned above, wherein each side frame is configured with the folding mechanism, and an unlocking mechanism is arranged between two of the front bottom pivot ends for unlocking or locking a rotation of the second folding member.

The collapsible cart as mentioned above, wherein the unlocking mechanism comprises a rotating lever which drives the side frame to fold once the rotation of the second folding member is unlocked, and an unlocking member for unlocking or locking a relative rotation of the front bottom rod and the rear bottom rod.

The collapsible cart as mentioned above, wherein the unlocking member is configured to lock a relative rotation between the front bottom rod and the rear bottom rod when in the fully unfolded state; when folding of the cart is required, the unlocking member is configured to unlock the relative rotation of the front bottom rod and the rear bottom rod, and the cart is fully folded as the rotating lever drives the folding mechanism to fold.

The collapsible cart as mentioned above, wherein the unlocking member comprises a sliding lock member sleeved outside the rotating lever and a locking pin which is disposed inside the rotating lever and driven by the sliding lock member, wherein the rear bottom rod is configured with a locking hole into which the locking pin is inserted for limiting folding of the side frame, when the cart is in the unfolded state, the front bottom pivot end abuts against the rear bottom rod, and the locking pin is inserted into the locking hole; when the sliding lock member drives the locking pin to disengage from the locking hole, a rotational state of the front bottom rod and the rear bottom rod is unlocked.

The collapsible cart as mentioned above, wherein the unlocking member comprises a pair of sliding lock members sleeved outside the rotating lever, a pair of locking pins which are arranged inside the rotating lever and driven by the sliding lock members, and a locking hole disposed on each rear bottom rod at a side face to the rotating lever, wherein an elastic member is arranged between two of the locking pins for pressing the locking pins on both sides into the locking holes and a pulling member is arranged between the two sliding lock members for pulling the two sliding lock members to move close to each other so that the locking pins are disengaged from the locking holes.

Compared with the prior art, the compact collapsible cart provided by the present invention has the following beneficial effects:
the folding mechanism of the present invention drives the front frame and the rear frame to synchronously move toward or away from the folding mechanism, which realizes dynamic linkage during unfolding and folding of the cart, thereby effectively reducing gaps between the front frame and the rear frame after folding, optimizing space utilization of the folding, and significantly improving folding compactness while ensuring structural strength.

### BRIEF DESCRIPTION OF THE DRAWINGS

In order to clearly illustrate the technical solutions of the embodiments of the present invention, a brief introduction to the accompanying drawings required for the description of the embodiments is given below.

FIG. 1 is a structural schematic view of a fully unfolded state from one perspective according to the present invention;

FIG. 2 is a structural schematic view of a fully unfolded state from another perspective according to the present invention;

FIG. 3 is a structural schematic view of the side frame and folding mechanism according to the present invention;

FIG. 4 is an exploded view of FIG. 3;

FIG. 5 is a structural schematic view of the front frame, rear frame and side frame in the folded state according to the present invention;

FIG. 6 is a structural schematic view of the unlocking mechanism in detached state according to the present invention;

FIG. 7 is an enlarged schematic view of area A in FIG. 6.

Wherein, the reference numerals correspond as follows:

1—front frame; 2—rear frame; 3—side frame; 30—folding mechanism; 301—first folding member; 3011—first rotating end; 3012—second rotating end; 302—second folding member; 3021—front bottom pivot end; 3022—rear bottom pivot end; 303—auxiliary folding rod; 3031—sliding sleeve; 3032—first linking member; 3033—second linking member; 31—front top rod; 32—front bottom rod; 33—rear top rod; 34—rear bottom rod; 4—unlocking mechanism; 41—rotating lever; 42—unlocking member; 421—sliding lock member; 422—locking pin; 423—locking hole; 424—pulling member.

### DETAILED DESCRIPTION OF THE DRAWINGS AND THE PRESENTLY PREFERRED EMBODIMENTS

In order to make the technical problems, technical solutions and beneficial effects solved by the present invention more clearly, the present invention is further illustrated hereafter in combination with the accompany drawings and embodiments. It should be understood that the embodiments described here are only used for explaining the present invention but not to limit the present invention.

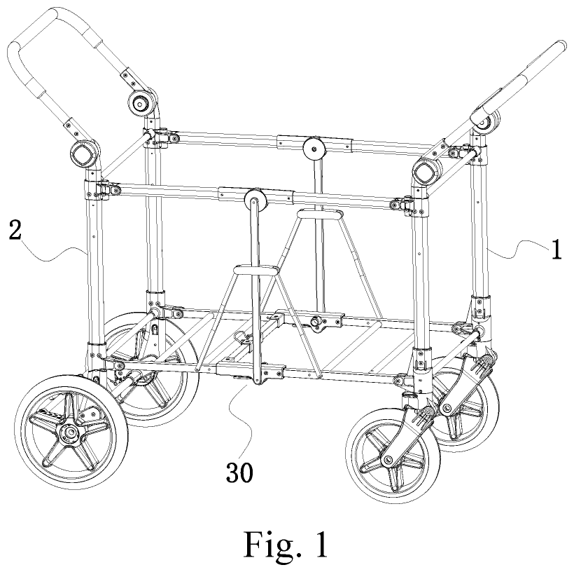

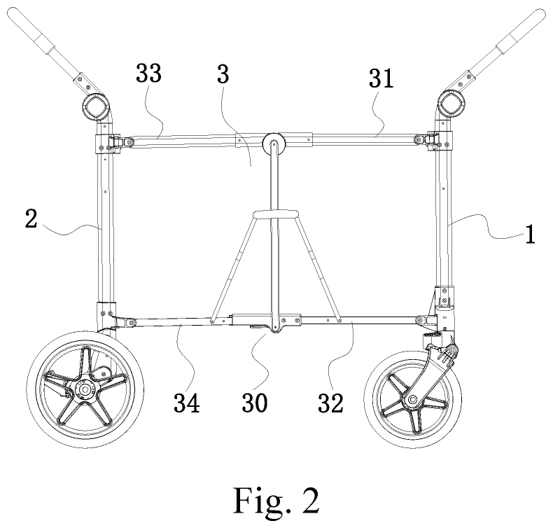

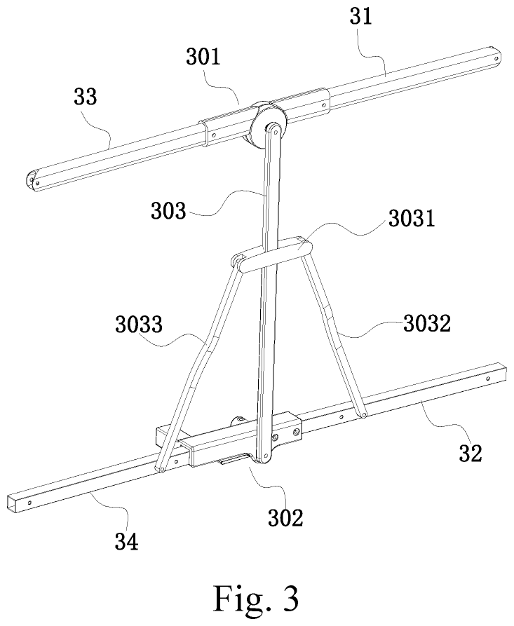

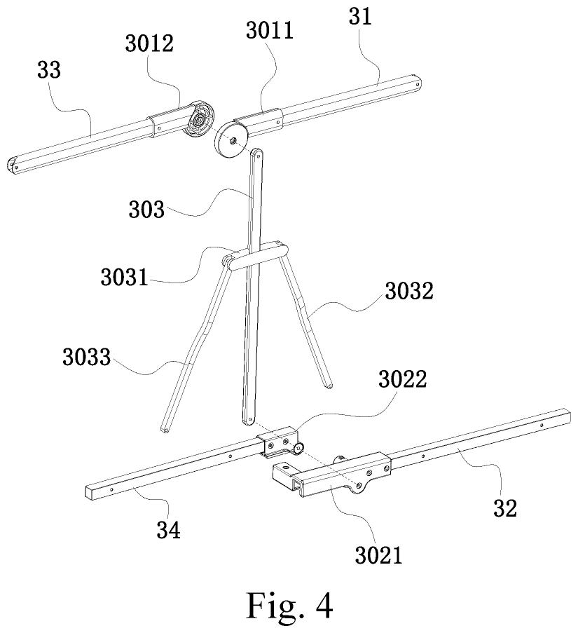

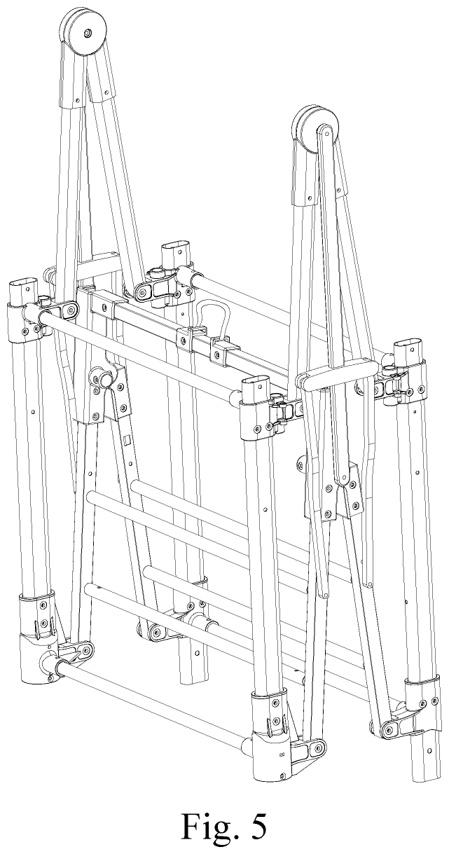

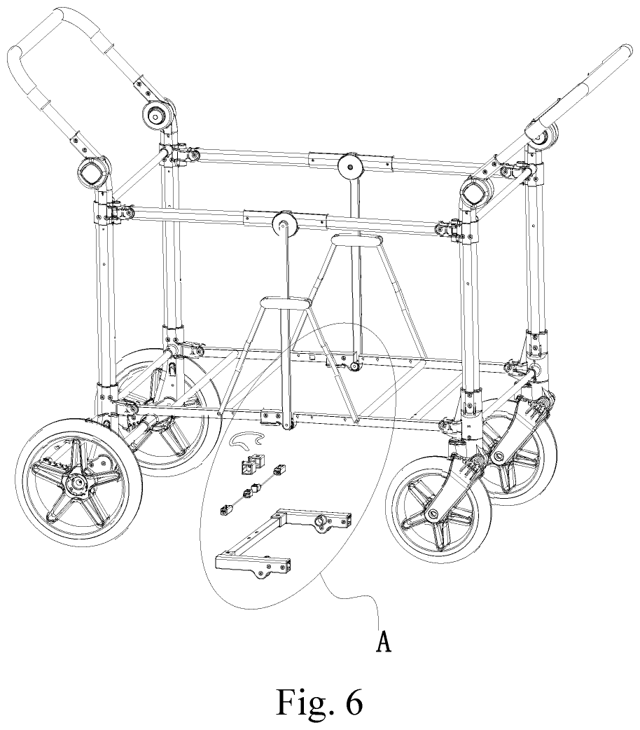

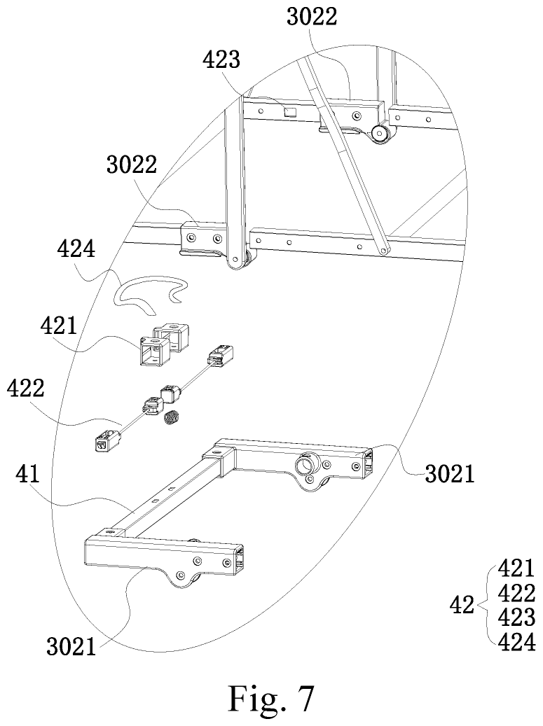

The specific embodiments, in combination with FIG. 1 to FIG. 7, further illustrated the technical solutions of the present invention. A compact collapsible cart comprises a front frame 1, a rear frame 2 and at least one side frame 3 configured between the front frame 1 and the rear frame 2 for folding and unfolding the cart; wherein a folding mechanism 30 is configured in a middle of the side frame 3 for driving both the front frame 1 and the rear frame 2 to move toward or away from the folding mechanism 30, so as to achieve folding and unfolding of the cart.

In this case, the folding mechanism 30 drives the front frame 1 and the rear frame 2 to synchronously move toward or away from the folding mechanism, which realizes dynamic linkage during unfolding and folding of the cart, thereby effectively reducing gap between the front frame 1 and the rear frame 2 after folding, optimizing space utilization of the folding, and significantly improving folding compactness while ensuring structural strength.

When the folding mechanism 30 drives the side frame 3 to fold, the front frame 1 and the rear frame 2 move close to the folding mechanism 30, and meanwhile the side frame 3 fold correspondingly with the movement of the folding mechanism 30, so that the front frame 1 and the rear frame 2 are gathered for easy storage;

Once the side frame 3 is unfolded, the folding mechanism 30 moves to cooperate with the side frame 3 to unfold. Meanwhile, the gap between the front frame 1 and the rear frame 2 is increased along with the unfolding of the side frames 3 until fully unfolded, so as to be used as the cart.

In this embodiment, the side frame 3 comprises a front top rod 31 and a front bottom rod 32 whose front ends are pivotally connected to upper side and lower side of the front frame 1 respectively, and a rear top rod 33 and a rear bottom rod 34 whose rear ends are pivotally connected to upper side and lower side of the rear frame 2. The folding mechanism 30 comprises a first folding member 301 pivotally connected to both the front top rod 31 and the rear top rod 33, a second folding member 302 pivotally connected to both the front bottom rod 32 and the rear bottom rod 34, and an auxiliary folding rod 303 configured between the first folding member 301 and the second folding member 302 for connection therebetween.

The front top rod 31 and the front bottom rod 32 are pivotally connected to the upper side and the lower side of the front frame 1 respectively, and the rear top rod 33 and the rear bottom rod 34 are pivotally connected to the upper side and the lower side of the rear frame 2 respectively, forming a multi-point support folding motion. The first folding member 301 and the second folding member 302 respectively drive the front top rod 31 and the rear top rod 33 as well as the front bottom rod 32 and the rear bottom rod 34 to rotate. Meanwhile, coordinated movement is realized via the auxiliary folding rod 303, achieve synchronous folding toward each other or unfolding away from each other of the front frame 1, the rear frame 2 and the side frame 3. When the cart is folded, the folding of the front top rod 31 and the rear top rod 33 and/or the folding of the front bottom rod 32 and the rear bottom rod 34 are driven by the rotating shaft ends of the first folding member 301 and the second folding member 302, which effectively eliminates folding gaps, allows the front frame 1 and the rear frame 2 to be gathered in the folded state, greatly reduces the occupied space, and meanwhile enhances the overall structural stability and folding consistency.

Further, one side of the first folding member 301 is configured with a first rotating end 3011 fixedly connected to the front top rod 31, and the other side of the first folding member 301 is configured with a second rotating end 3012 fixedly connected to the rear top rod 33, wherein the first rotating end 3011 and the second rotating end 3012 are rotatably connected.

One side of the second folding member 302 is configured with a front bottom pivot end 3021 fixedly connected to the front bottom rod 32, and the other side of the second folding member 302 is configured with a rear bottom pivot end 3022 fixedly connected to the rear bottom rod 34, wherein the front bottom pivot end 3021 and the rear bottom pivot end 3022 are rotatably connected.

In this case, during folding, the front frame 1 and the rear frame 2 synchronously move close to the folding mechanism 30 via rotatable connection, significantly improving compactness and reducing folding gaps.

Specifically, during the folding of the side frame 3, the front top rod 31 and the rear top rod 33 rotate with the rotation of the first rotating end 3011 and the second rotating end 3012, so that an angle between the front top rod 31 and the rear top rod 33 is reduced; or the front bottom rod 32 and the rear bottom rod 34 rotate with the rotation of the front bottom pivot end 3021 and the rear bottom pivot end 3022, so that the angle between the front bottom rod 32 and the rear bottom rod 34 is reduced. Therefore, while the side frame 3 is folded, the front frame 1 and the rear frame 2 are gathered to reduce folding gaps.

Further, rotational axis of the first folding member 301 is parallel to rotational axis of the second folding member 302, and a plane defined by the rotational axes of the first folding member 301 and the second folding member 302 is parallel to planes of the front frame 1 and the rear frame 2.

The rotational axes of the first folding member 301 and the second folding member 302 are parallel to each other, and the plane defined by the two rotational axes is parallel to the planes of the front frame 1 and the rear frame 2. This ensures that all members move coordinately along the same plane during folding and avoids the risk of frame offset caused by non-parallel axes. In addition, such design enables the front frame 1 and the rear frame 2 to fit closer to the plane defined by the rotational axes of the first folding member 301 and the second folding member 302 after folding, reduces folding gaps and improves space utilization. Meanwhile, the parallel axis layout enhances structural stability and prevents torsional deformation during folding.

Optionally, one end of the auxiliary folding rod 303 is rotatably connected to the first folding member 301, and the other end thereof is rotatably connected to the second folding member 302, wherein the side frame 3 is axisymmetrical about the auxiliary folding rod 303.

The layout that the side frame 3 is axisymmetrical about the auxiliary folding rod 303 ensures uniform stress on the side frame 3. During folding, the front frame 1 and the rear frame 2 move toward the folding mechanism 30 synchronously, avoiding folding offset caused by an asymmetric structure, optimizing the symmetry and stability of the folding. The front frame 1 and the rear frame 2 are closely attached in the folded state, significantly improving the folding compactness and space utilization.

Further, the folding mechanism 30 further comprises a sliding sleeve 3031 disposed on the auxiliary folding rod 303 which moves along an axis direction of the auxiliary folding rod 303, and a first linking member 3032 and a second linking member 3033 which slide along with the sliding sleeve 3031 and respectively drive the front bottom rod 32 and the rear bottom rod 34 to move.

When the sliding sleeve 3031 slides along the axis of the auxiliary folding rod 303, the first linking member 3032 and the second linking member 3033 respectively drive the front bottom rod 32 and the rear bottom rod 34 to move synchronously, forming a multi-directional linked folding motion, enabling the front frame 1 and the rear frame 2 to closely approach each other along the same plane during folding, reducing gaps and offset after folding, and significantly improving folding efficiency as well as folding compactness.

Further, one end of the first linking member 3032 is pivotally connected to the sliding sleeve 3031, the other end thereof is pivotally connected to the front bottom rod 32. One end of the second linking member 3033 is pivotally connected to the sliding sleeve 3031, the other end thereof is pivotally connected to the rear bottom rod 34.

The first linking member 3032 is pivotally connected to the front bottom rod 32 and the sliding sleeve 3031 respectively, and the second linking member 3033 is pivotally connected to the rear bottom rod 34 and the sliding sleeve 3031, forming a dynamic traction path. When folding is performed, due to the fixed length limitation of each rod, the folding motion drives the sliding sleeve 3031 to slide. With the guiding of the auxiliary folding rod 303, the front bottom rod 32 and the rear bottom rod 34 are synchronously driven to complete folding, and the front frame 1 and the rear frame 2 approach each other synchronously along a preset trajectory, which optimizes the accuracy and synchronism of the folding motion, significantly reduces folding gaps, and improves folding compactness and space utilization.

Further, the first linking member 3032 and the second linking member 3033 is axisymmetrical about the auxiliary folding rod 303. The first linking member 3032 and the second linking member 3033 is axisymmetrical about the auxiliary folding rod 303, achieving precise and axisymmetrical control of the folding motion.

Optionally, each side frame 3 is configured with the folding mechanism 30, and an unlocking mechanism 4 is arranged between two of the front bottom pivot ends 3032 for unlocking or locking a rotation of the second folding member 302.

The collaborative design of the bilateral folding mechanisms 30 and the unlocking mechanism 4 achieves high efficiency and stability of the folding operation. Specifically, the independent folding mechanism 30 on each side frame ensures that the front frame 1 and the rear frame 2 approach each other synchronously, eliminating the risk of offset caused by unilateral force. The unlocking mechanism 4 realizes precise locking and quick unlocking of the second folding member 302 by linking the two front bottom pivot ends 3021, simplifies the user operation, optimizes the symmetry and operation convenience of the folding motion, significantly improves folding compactness and storage efficiency, and enhances structural stability simultaneously.

In this embodiment, the unlocking mechanism 4 comprises a rotating lever 41 which drives the side frame 3 to fold once the rotation of the second folding member 302 is unlocked, and an unlocking member 42 for unlocking or locking a relative rotation of the front bottom rod 32 and the rear bottom rod 34.

When in the fully unfolded state, the unlocking member 42 locks the relative rotation between the front bottom rod 32 and the rear bottom rod 34. When it is necessary to fold the cart, the unlocking member 42 is controlled to unlock the relative rotation of the front bottom rod 32 and the rear bottom rod 34, and the rotating lever 41 drives the folding mechanism 30 to complete folding of the cart.

Further, the unlocking member 42 comprises a sliding lock member 421 sleeved outside the rotating lever 41, and a locking pin 422 which is disposed inside the rotating lever 41 and driven by the sliding lock member 421. The rear bottom rod 34 is configured with a locking hole 423 into which the locking pin 422 is inserted for limiting folding of the side frame 3. When the cart is in the unfolded state, the front bottom pivot end 3021 abuts against the rear bottom rod 34, and the locking pin 422 is inserted into the locking hole 423. When the sliding lock member 421 drives the locking pin 422 to disengage from the locking hole 423, the rotational state of the front bottom rod 32 and the rear bottom rod 34 is unlocked.

Further, the unlocking member 42 comprises a pair of sliding lock members 421 sleeved outside the rotating lever 41, and a pair of locking pins 422 which are arranged inside the rotating lever 41 and driven by the sliding lock members 421. A locking hole 423 is disposed on each rear bottom rod 34 at a side face to the rotating lever 41. An elastic member is arranged between two of the locking pins 422, so as to press the locking pins on both sides into the corresponding locking holes 423 in the fully unfolded state. A pulling member 424 is arranged between the two sliding lock members 421, and is operable to pull the two sliding lock members 421 to move close to each other, thereby causing the locking pins 422 to disengage from the locking holes 423.

Optionally, the pulling member 424 is an elastic pulling rope.

In the compact collapsible cart provided by the present invention, when the folding mechanism 30 drives the side frame 3 to fold, the unlocking member 42 unlocks the relative rotation between the front bottom rod 32 and the rear bottom rod 34, and the rotating lever 41 drives the folding mechanism 30 to move. Meanwhile the sliding sleeve 3031 slides along the axis of the auxiliary folding rod 303, the first linking member 3032 and the second linking member 3033 respectively drive the front bottom rod 32 and the rear bottom rod 34 to move synchronously, and the auxiliary folding rod 303 moves in coordination therewith, realizing synchronous folding toward each other of the front frame 1, the rear frame 2 and the side frame 3, gathering the front frame 1 and the rear frame 2 together, and facilitating storage.

When the side frame 3 is unfolded, the folding mechanism 30 moves to cooperate with the side frame 3 to unfold. Meanwhile, the gap between the front frame 1 and the rear frame 2 is increased along with the unfolding of the side frames 3 until fully unfolded, so as to be used as the cart.

In summary, the folding mechanism 30 drives the front frame 1 and the rear frame 2 to synchronously move toward or away from the folding mechanism, which realizes dynamic linkage during unfolding and folding of the cart, thereby effectively reducing gap between the front frame 1 and the rear frame 2 after folding, optimizing space utilization of the folding, and significantly improving folding compactness while ensuring structural strength.

1. A collapsible cart, comprising a front frame, a rear frame and at least one side frame configured between the front frame and the rear frame for unfolding and folding the cart,
wherein a folding mechanism is configured in a middle of the side frame for driving both the front frame and the rear frame to move toward or away from the folding mechanism for unfolding and folding the cart.

2. The collapsible cart according to claim 1, wherein the side frame is configured to fold or unfold correspondingly with a movement of the folding mechanism such that the front and the rear frame are gathered or expanded.

3. The collapsible cart according to claim 1, wherein the side frame comprises:
a front top rod and a front bottom rod whose front ends are pivotally connected to an upper side and a lower side of the front frame respectively, and
a rear top rod and a rear bottom rod whose rear ends are pivotally connected to an upper side and a lower side of the rear frame respectively;
wherein the folding mechanism comprises a first folding member pivotally connected to both the front top rod and the rear top rod, and a second folding member pivotally connected to both the front bottom rod and the rear bottom rod.

4. The collapsible cart according to claim 3, wherein one side of the first folding member is configured with a first rotating end fixedly connected to the front top rod, the other side is configured with a second rotating end fixedly connected to the rear top rod, and the first rotating end and the second rotating end are rotatably connected;
wherein one side of the second folding member is configured with a front bottom pivot end fixedly connected to the front bottom rod, the other side is configured with a rear bottom pivot end fixedly connected to the rear bottom rod, and the front bottom pivot end and the rear bottom pivot end are rotatably connected.

5. The collapsible cart according to claim 4, wherein the front top rod and the rear top rod are configured to rotate with a rotation of both the first rotating end and the second rotating end during a folding of the side frame, so as to reduce an angle between the front top rod and the rear top rod; and
the front bottom rod and the rear bottom rod are configured to rotate with a rotation of both the front bottom pivot end and the rear bottom pivot end during the folding of the side frame, so as to reduce an angle between the front bottom rod and the rear bottom rod, and gather the front frame and the rear frame while the side frame is folded.

6. The collapsible cart according to claim 3, wherein a rotational axis of the first folding member is parallel to a rotational axis of the second folding member, and a plane defined by rotational axes of the first folding member and the second folding member is parallel to planes of the front frame and the rear frame.

7. The collapsible cart according to claim 3, wherein an auxiliary folding rod is configured between the first folding member and the second folding member for connection therebetween;
one end of the auxiliary folding rod is rotatably connected to the first folding member, and the other end is rotatably connected to the second folding member; wherein the side frame is axisymmetrical about the auxiliary folding rod.

8. The collapsible cart according to claim 7, wherein the folding mechanism further comprises a sliding sleeve disposed on the auxiliary folding rod which moves along an axis direction of the auxiliary folding rod, and a first linking member and a second linking member which slide along with the sliding sleeve and respectively drive the front bottom rod and the rear bottom rod to move.

9. The collapsible cart according to claim 8, wherein one end of the first linking member is pivotally connected to the sliding sleeve, the other end is pivotally connected to the front bottom rod;
wherein one end of the second linking member is pivotally connected to the sliding sleeve, the other end is pivotally connected to the rear bottom rod.

10. The collapsible cart according to claim 9, wherein the first linking member and the second linking member is axisymmetrical about the auxiliary folding rod.

11. The collapsible cart according to claim 4, wherein each side frame is configured with the folding mechanism, and an unlocking mechanism is arranged between two of the front bottom pivot ends for unlocking or locking a rotation of the second folding member.

12. The collapsible cart according to claim 11, wherein the unlocking mechanism comprises a rotating lever which drives the side frame to fold once the rotation of the second folding member is unlocked, and an unlocking member for unlocking or locking a relative rotation between the front bottom rod and the rear bottom rod.

13. The collapsable cart according to claim 12, wherein the unlocking member is configured to lock the relative rotation between the front bottom rod and the rear bottom rod when the cart is fully unfolded;
when the cart is to be folded, the unlocking member is configured to unlock the relative rotation of the front bottom rod and the rear bottom rod, and the cart is fully folded as the rotating lever drives the folding mechanism to fold.

14. The collapsable cart according to claim 12, wherein the unlocking member comprises a sliding lock member sleeved outside the rotating lever and a locking pin which is disposed inside the rotating lever and driven by the sliding lock member, wherein the rear bottom rod is configured with a locking hole into which the locking pin is inserted for limiting the folding of the side frame,
when the cart is in an unfolded state, the front bottom pivot end abuts against the rear bottom rod, and the locking pin is inserted into the locking hole; when the sliding lock member drives the locking pin to disengage from the locking hole, the relative rotation between the front bottom rod and the rear bottom rod is unlocked.

15. The collapsable cart according to claim 12, wherein the unlocking member comprises a pair of sliding lock members sleeved outside the rotating lever, a pair of locking pins which are arranged inside the rotating lever and driven by the sliding lock members,
wherein a locking hole disposed on each rear bottom rod at a side face to the rotating lever, an elastic member is arranged between two of the locking pins for pressing the locking pins on both sides into the locking holes,
wherein a pulling member is arranged between the pair of sliding lock members for pulling the pair of sliding lock members to move close to each other such that the locking pins are disengaged from the locking holes.
